(19) United States
(12) Patent Application Publication
(10) Pub. No.: US 2024/0355167 A1
(43) Pub. Date: Oct. 24, 2024

(54) AUTOMATIC BEVERAGE VENDING MACHINE

(71) Applicant: RHEAVENDORS INDUSTRIES S.P. A., COMO (IT)

(72) Inventors: Fabio BRUZZESE, Como (IT); Claudio MAGGIONI, Como (IT); Roberto RIVA, Como (IT); Gianluca PIATTI, Como (IT); Carlo MOLINATI, Como (IT); Claudio BELTRAME, Como (IT)

(21) Appl. No.: 18/560,201

(22) PCT Filed: May 10, 2022
(86) PCT No.: PCT/IB2022/054325

§ 371 Date: Nov. 10, 2023

(30) Foreign Application Priority Data
May 10, 2021 (IT) 102021000011945

(51) Int. Cl. G07F 13/10

(52) U.S. Cl. CPC G07F 13/10

(57) ABSTRACT

An automatic beverage vending machine having a cabinet and closed by a door houses a beverage preparation assembly and at least one dispensing assembly of bodies for containing/mixing the same beverages; the dispensing assembly of containment/mixing bodies being coupled to the door by means of a quick coupling and locking device having at least one pair of retention pins stably connected to the dispensing assembly and a shaped retention plate stably connected to the door and delimiting for each retention pin a guide slot configured to be crossed by an attachment head of the retention pin and to guide a shaft of the same retention pin.

### CROSS-REFERENCE TO RELATED APPLICATIONS

This patent application claims priority from Italian patent application no. 102021000011945 filed on May 10, 2021, the entire disclosure of which is incorporated herein by reference.

### TECHNICAL FIELD OF THE INVENTION

The present invention relates to an automatic beverage vending machine.

### STATE OF THE ART

As is known, the automatic beverage vending machines comprise a cabinet or container, which has a front access opening closed by a door and houses a plurality of assemblies for producing beverages.

Each cabinet also houses one or more different sub-assemblies that can be configured during the assembly of the vending machine according to the purchaser's requirements.

Examples of these sub-assemblies and the relative configurations may be:
a dispenser of paper or plastic cups of different diameters, for example. 58 mm. 70 mm. 73 mm and 80 mm; the cup dispenser can then be with a single turret or with two or more turrets for feeding the same cups;
a dispenser of lids for closing the cups. In some embodiments, such a lid dispenser may not be provided; and
a dispenser of stir sticks of different sizes, is also present or not depending on the application.

The above sub-assemblies have support and attachment structures, which are in some cases connected to portions of the cabinet or to attachment frames also housed in the cabinet, or are connected to the door to move together with the door itself.

The connection to the door is generally preferred as the opening of the door makes the sub-assemblies directly and easily accessible.

Regardless of the arrangement of the sub-assemblies, they are fixed to the relative attachment frames or to the door by means of connecting elements such as screws, pins, Seeger rings.

The insertion of these elements is subject to the use of tools and implements that are not always easy to use because of the compactness of the known vending machines and therefore of the reduced space for manoeuvre.

An automatic beverage vending machine is described in D1, while D2 describes an automatic beverage vending machine in which two parts are connected to each other by pins sliding in overturned keyhole slots.

Document D5 describes a snap-on quick coupling device having a sliding slot for a retention peg and snap-on locking teeth of the peg within the slot.

The Applicant has been able to ascertain that, although they guarantee high stability, such connecting elements do not allow, however, to satisfy the ever-increasing need to be able to install sub-assemblies in a short time, but above all to be able to replace sub-assemblies in machines already in operation so as to reconfigure or retro-fit them, that is to say to adapt them easily and quickly to new dispensing requirements, with low efforts on the part of the operator and without the need to use loose fasteners and mechanical tools and mechanical implements for the insertion and extraction of these fasteners.

### SUBJECT AND SUMMARY OF THE INVENTION

Aim of the present invention is to realize an automatic beverage vending machine, which enables the problems set out above to be solved in a simple and economical manner so as to be able to meet the need indicated above.

According to the present invention, an automatic beverage vending machine is realized, as claimed in the appended claims.

### BRIEF DESCRIPTION OF THE DRAWINGS

FIG. 1 is a perspective view, with parts removed for clarity's sake, of a preferred embodiment of an automatic beverage vending machine realized according to the dictates of the present invention.

FIG. 2 is a perspective view, on an enlarged scale, of a detail of FIG. 1 with parts decoupled for clarity's sake.

FIGS. 3 to 5 show, in front view, a coupling device of parts of the beverage vending machine of FIG. 1 arranged in three different coupling conditions.

FIG. 6 is a section, on a greatly enlarged scale, according to the line VI-VI of FIG. 5 with parts removed for clarity's sake.

FIGS. 7 and 8 show, on an enlarged scale and with parts removed for clarity's sake. two different details of FIG. 3 and FIG. 5, respectively.

### DETAILED DESCRIPTION OF PREFERRED EMBODIMENTS OF THE INVENTION

The present invention will now be described in detail with reference to the accompanying figures to allow a skilled person to make and use it. Various modifications of the embodiment described will be immediately clear to the skilled person and the general principles disclosed can be applied to other embodiments and applications without departing from the protection scope of the present invention, as defined in the enclosed drawings. Therefore, the present invention shall not be limited to the shown and described embodiments, but it must be granted the widest protection scope in accordance with the features disclosed and claimed.

Unless otherwise defined, all the herein used technical and scientific terms have the same meaning commonly used by the ordinary skilled in the art of the present invention. In case of conflict, the present invention, including definitions provided, will be binding. Furthermore, the examples are provided for merely illustrative purposes and must not be regarded as limiting.

In order to case the understanding of the herein described embodiments. reference will be made to some specific embodiments and a specific language will be used to describe them. The terminology used in the present document aims at describing only particular implementations, and is not intended to limit the scope of the present invention.

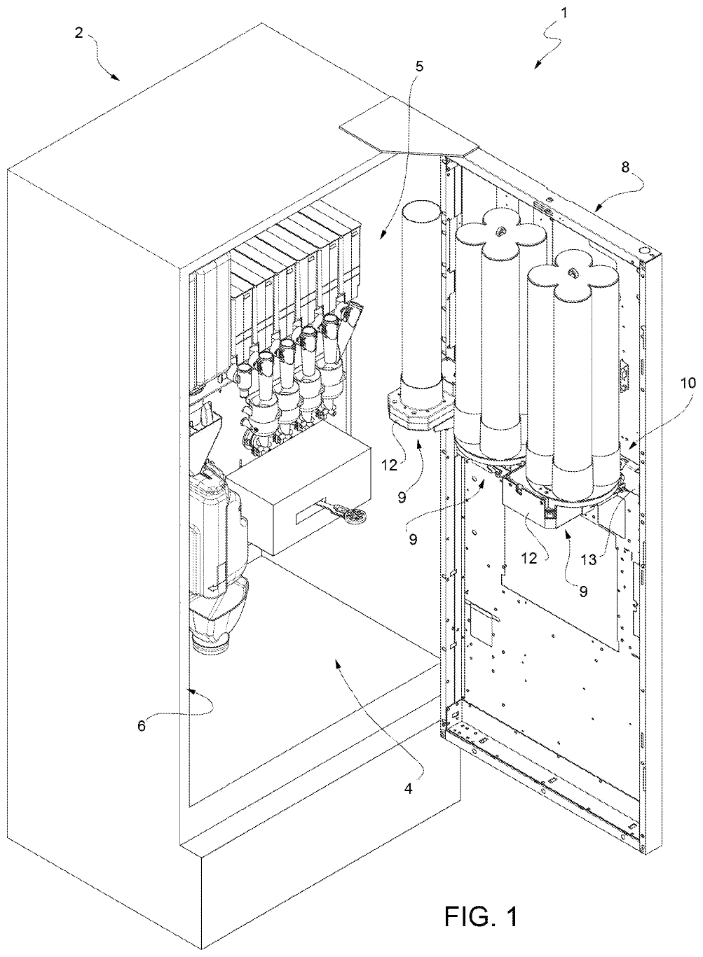

In FIGS. 1, reference number 1 denotes an automatic beverage vending machine as a whole.

The automatic beverage vending machine 1 comprises a cabinet 2. in turn, comprising a box-shaped body 3 and a chamber 4 housing an assembly for preparing and dispensing one or more beverages, per se known and not described in detail and indicated by reference number 5.

The chamber 4 communicates with the outside through an access opening 6 closed by a flap door 8, which forms part of the cabinet 2.

The automatic beverage vending machine 1 also comprises three turret dispensing assemblies 9, commonly known as “feeding sub-assemblies”, for feeding paper or plastic cups of different sizes and, depending on the applications, also lids for closing the same cups and stir sticks. However, the dispensing assemblies of the closing lid and sticks may be missing.

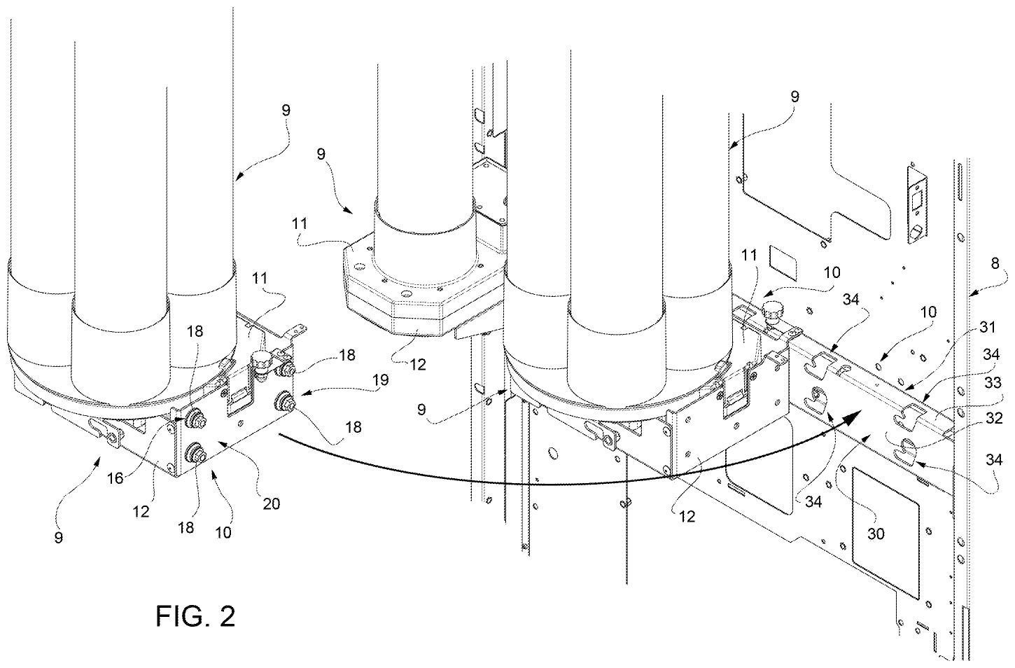

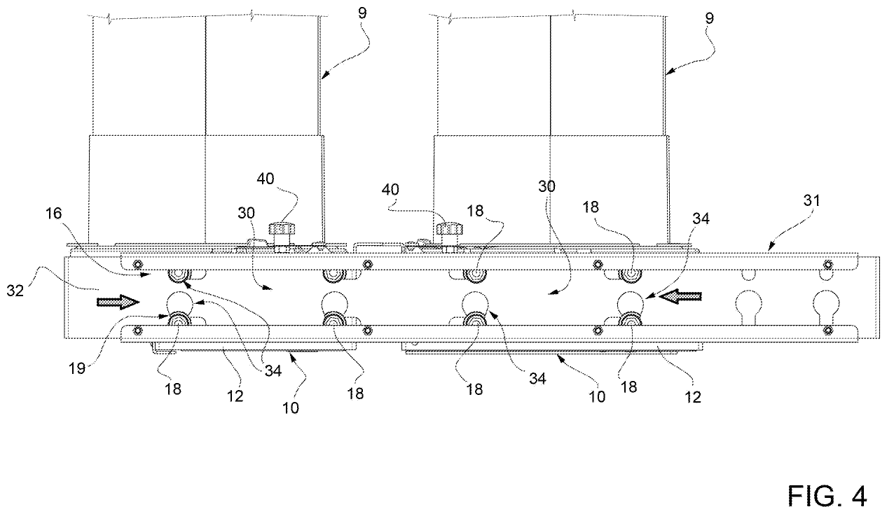

The dispensing assemblies 9 are carried by the door 8 and each is connected to the door 8 in a releasable or dismountable manner by a respective quick coupling and locking device 10 (FIGS. 2 and 3 to 6) independent of the other quick coupling and locking devices 10.

In particular, each dispensing assembly 9 comprises a dispensing base 11, per se known and not described, and its own attachment frame 12 partially or completely housing the relative dispensing base 11.

Each quick coupling and locking device 10 comprises an upper pair 16 of retention pins 18 and a lower pair 19 of retention pins 18 vertically spaced from one another. The pins 18 protrude in a cantilever fashion from a surface 20 of the frame 12 facing the door 8.

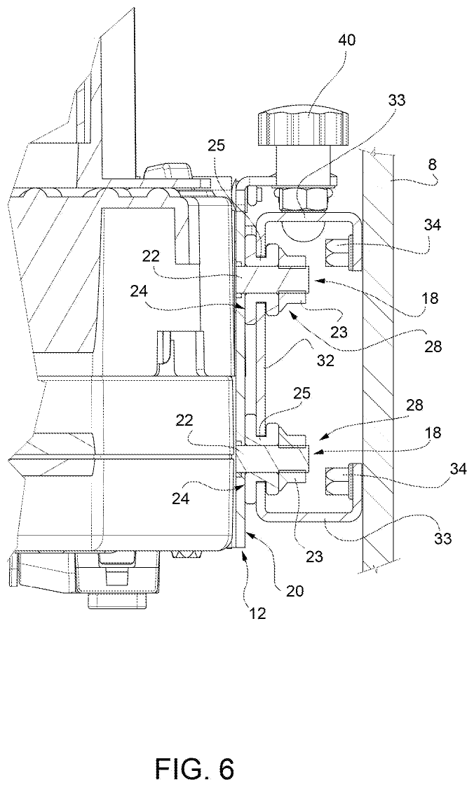

With reference to FIG. 6, each retention pin 18 comprises a shaft 22, which is stably connected to the frame 12 and ends with an externally threaded segment, onto which a tightening nut 23 is screwed. Conveniently, a shaped collar 24, preferably, but not necessarily, made of an anti-friction material, is fitted on the shaft 22 and tightened against the surface 20 of the frame 12 by the relative nut 23. Each collar 24 has, in cross-section, a substantially H shape (FIG. 6) and comprises a central cylindrical portion 25 and two lateral circular flanges 26 and 27. of which the flange 27 has an outer diameter smaller than the outer diameter of the flange 26 and is positioned abutting against the relative nut 23 in order to define, with the nut 23 itself, an attachment head 28 of the relative retention pin 18.

The flange 26, on the other hand. is positioned abutting against the surface 20 and delimits, with the cylindrical annular portion 25 and with the flange 27, a circumferential groove 29.

According to a variant not shown, each retention pin 18 is free of its relative collar 24 and the attachment head 28 is defined only by the nut 23.

Still with reference to FIGS. 2 and 3 to 5, each quick coupling and locking device 10 further comprises a relative shaped attachment plate 30 of the pins 18 and fixed to the door 8.

Conveniently, the shaped plates 30 constitute consecutive segments of a shaped crosspiece 31 that is common to all the dispensing assemblies 9 and stably connected to the door 8.

According to a variant, not shown, the shaped attachment plates 30 are separated from each other and each stably connected to the door 8.

Regardless of whether they are separated or parts of a single crosspiece 31. each shaped plate 30 is C-shaped (FIGS. 2 and 6) and comprises a vertical intermediate wall 32 and two horizontal side walls or wings 33 stably connected to the door 8 by means of nuts 34A.

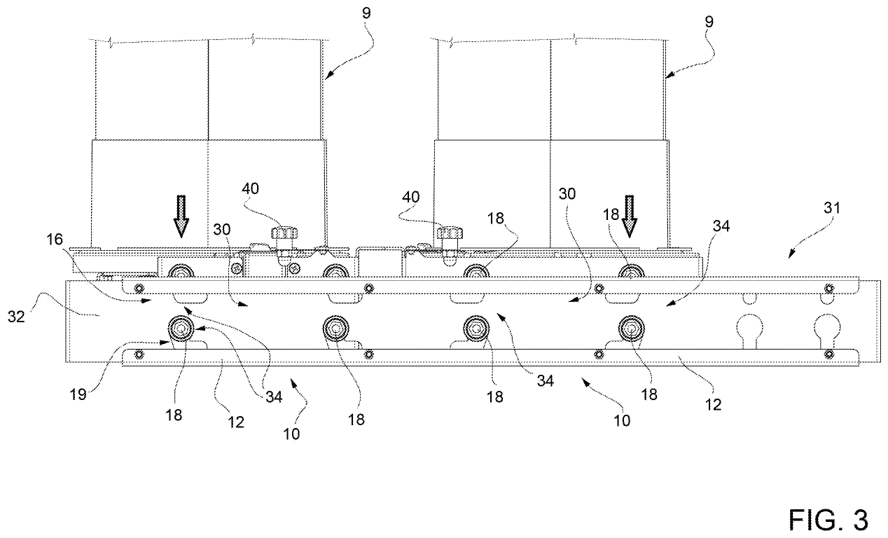

Each intermediate wall 32 comprises, for each retention pin 18, a relative shaped retention and guide slot of the relative pin 18, indicated by 34 (FIGS. 3 to 5 and 7).

Each slot 34 comprises a vertical segment 35. a horizontal segment 36 and an inlet passage 37 arranged above the vertical segment 35 and communicating with the vertical segment 35 itself.

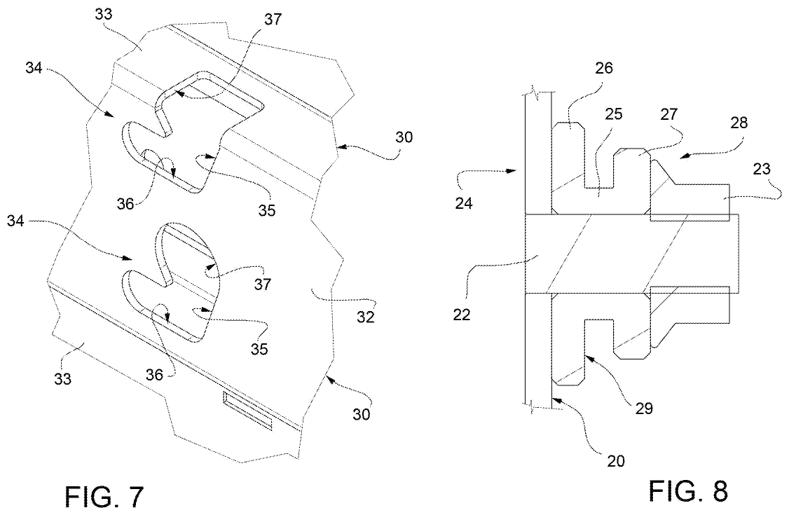

With particular reference to FIG. 7. part of the inlets 37 is obtained on the intermediate wall 32. the remaining part of the inlets 37 is obtained through the upper wing 33. The inlets 37 obtained through the wing 33 are inlets which are open upwards so as to allow the relative attachment head 28 to be inserted into the respective slot 34 by simply sliding in a vertical direction.

According to a variant not shown, all the inlets are obtained on the intermediate wall 32.

In any case, each inlet 37 is configured to be crossed by the attachment head 28 of the relative pin 18. i.e. by the relative nut 23 and by the relative flange 27, but not by the relative flange 26.

The segments 35 and 36, on the other hand, are shaped so as to have a width approximating by excess the outer diameter of the relative tubular portion 25 so as to allow the tubular portion 25 itself to slide freely within the segments 35 and 36.

In the absence of the collars 24, the segments 35 and 36 have a width approximating by excess the shaft diameter 22.

Considering for the sake of exposition only one dispensing assembly 9, the assembly and disassembly of the dispensing assembly 9 itself are carried out as follows.

With reference to FIG. 3, the frame 12 is brought into a position facing the crosspiece 31 by arranging the attachment heads 28 of the pins 18 at the relative inlets 37, after which the frame 12 is pushed against the crosspiece 31 and the attachment heads 28 of the pins advanced through the relative inlets 37 until the flanges 26 are brought against the wall 32.

At this point, the frame 12 is lowered by advancing the tubular portions 25 of the pins 18, firstly, along the vertical segments 35 until they rest on the horizontal segments 36 and, then, it is translated horizontally by moving the tubular portions 25 themselves inside the horizontal segments 36 until they are brought in abutment against the bottom surfaces of the horizontal segments 36 themselves.

Secondly, a variant not shown, the segments 35 and 36 extend along directions together forming an angle other than zero and 90°.

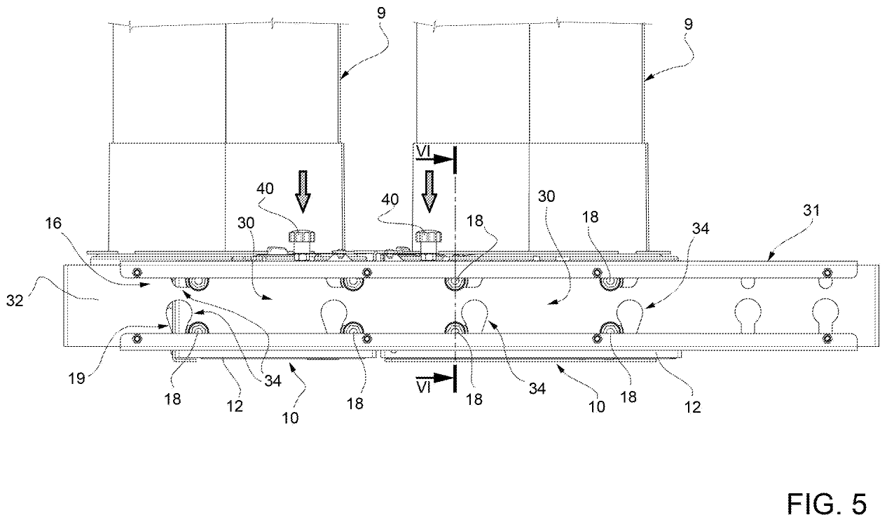

In this way, the pins 18 and thus the frame 12 are guided along predefined and invariant paths that bring the dispensing assembly 9 into a precise functional position. When the pins 18 are positioned abutting against the bottom surfaces of the segments 36, a locking pin 40 carried by the frame 12 and forming part of the quick coupling and locking device 10 is lowered and inserted into a retention seat obtained on the upper wing 33 of the crosspiece 31, as shown in FIG. 5.

Conveniently, each pin 40 is loaded with a spring so as to snap into its retention seat when the pins 18 reach the bottom surfaces of the segments 36.

From the foregoing. it is evident that the quick coupling and locking devices 10 allow each of the dispensing assemblies 9 to be installed/removed and replaced independently of each other without using any loose fasteners and without the use of any tools and mechanical implements.

In addition to this, each quick coupling and locking device 10 allows each dispensing assembly 9 to be arranged and locked in a unique and invariant position without the need for references and without attention on the part of the installer.

This facilitates, firstly, the operations for assembly or for the initial equipment of the vending machine 1, reducing the times, but above all, it allows the quick replacement of the dispensing assemblies 9 in machines already operating in service areas so as to reconfigure or retro-fit them, adapting them easily and quickly to new dispensing requirements and with low efforts on the part of the operator, who simply has to extract the peg 40 and decouple the entire dispensing assembly 9 by simply translation, lifting and replacement thereof with another dispensing assembly by repeating the same operations in reverse order.

From the foregoing, it is also evident that modifications and variations can be made without thereby leaving the protective scope defined by the independent claims. In particular, the retention pins 18 could be configured in a manner different from that shown, but still in order to form part of a sliding engagement and could be in a number different from that shown.

The same slots 35 and 36 could have geometries different from those shown.

Still, the automatic beverage vending machine 1 could comprise only one dispensing assembly 9.

Finally, the retention pins 18 could be carried by the shaped retention plates 30 and the slots 35 and 36 and the relative inlets 37 carried by the frame 12 of the dispensing assembly 9.

Finally, the pins 40 could be carried by the shaped retention plate 30 and the relative retention seat be carried by the dispensing assembly 9.

1. A beverage vending machine comprising a box-shaped body delimiting a housing chamber and an opening for access to said chamber; a door for closing said access opening; at least one dispensing assembly having bodies for containing/mixing said beverages and connection means for connecting said dispensing assembly to said closing door or to said box-shaped body, said connection means comprising a quick coupling and locking device; the quick coupling and locking device comprising:
an upper pair of retention pins and a lower pair of retention pins vertically spaced from one another, each retention pin being stably connected to one between said dispensing assembly and said closing door or said box-shaped body, and
a shaped retention plate stably connected to the other between said dispensing assembly and said closing door or said box-shaped body, the shaped retention plate being C-shaped and comprising a vertical intermediate wall and two horizontal wings stably connected to said other between said dispensing assembly and said closing door or said box-shaped body;
the shaped retention plate delimiting for each said retention pin at least one guide slot for guiding the relative retention pin;
each guide slot comprising a vertical segment, a horizontal segment and an inlet passage which is open upwards arranged above the vertical segment and communicating with the vertical segment itself;
the retention plate delimiting upper guide slots adapted for receiving the retention pins of said upper pair and lower guide slots adapted for receiving the retention pins of said lower pair;
each said retention pin comprising a shaft engaging the respective guide slot in a slidable manner, and an attachment head positioned abutting against a portion of said shaped plate delimiting the respective guide slot and insertable through the respective inlet passage;
each said attachment head comprising a portion provided with a circumferential groove engaged in a slidable manner by portions of said shaped retention plate delimiting the respective guide slot, the circumferential groove being laterally delimited between a first circular flange and a second circular flange, the second flange having an outer diameter smaller than the outer diameter of the first flange;
wherein each inlet passage is configured to be crossed by the attachment head of the relative retention pin in such a way that the second flange crosses the inlet passage whereas the first flange does not cross the inlet passage;
wherein each vertical segment and each a horizontal segment are shaped so as to have a width approximating by excess the outer diameter of each relative circumferential groove so as to allow the relative circumferential groove to slide freely within the vertical segment and the horizontal segment;
each said upper guide slot having a said inlet passage which is open upwards and which is obtained partly through the intermediate wall and partly through an upper wing of said horizontal wings;
the attachment head of each retention pin of said upper pair being insertable from above through said inlet passage which is open upwards of the respective said upper guide slot;
wherein the beverage vending machine further comprises releasable locking means being provided for locking said shafts in said guide slot.

2.-4. (canceled)

5. The vending machine according to claim 1, wherein the releasable locking means comprise a stop pin carried by one between said dispensing assembly and said retention plate and a retention seat engaged in a releasable manner by said pin and obtained on the other between said dispensing assembly and said retention plate.

6. (canceled)

7. The vending machine according to claim 1, wherein said shaped retention plate is stably connected to said door and in that said dispensing assembly comprises an attachment structure, to which the shafts of said retention pins are stably connected in a cantilever fashion.

8. The vending machine according to claim 1, wherein each said shaft comprises a stem and said attachment head comprises a nut screwed onto said stem.

9.-10. (canceled)
